(19) United States
(12) Patent Application Publication
(10) Pub. No.: US 2013/0002436 A1
(43) Pub. Date: Jan. 3, 2013

(54) System and Method for Managing Solder Paste

(75) Inventors: Shao-Chun CHANG, Taoyuan County (TW); Ching-Feng Hsieh, Taipei (TW)

(73) Assignees: Askey Computer Corporation, New Taipei City (TW); Askey Technology (Jiangsu) Ltd., JiangSu Province (CN)

(21) Appl. No.: 13/243,360

(22) Filed: Sep. 23, 2011

(30) Foreign Application Priority Data
Jun. 30, 2011 (TW) 100123045

(51) Int. Cl. G08B 17/00; G06F 19/00

(52) U.S. Cl. 340/588; 700/214; 340/584

(57) ABSTRACT

A system and a method for managing solder paste are disclosed. The storage information of solder paste cans stored in a storage room is established, production information is accessed from a production managing system for analyzing an amount of solder paste cans in need, the solder paste cans to be used are inquired and obtained from the storage room, and the solder paste cans are delivered to the warm up room for warm up treatment. The solder paste is thus systematically managed, such that the efficacy of management is improved and labor cost is reduced.

### BACKGROUND OF THE INVENTION

1. Field of the Invention

The present invention relates to a system and a method for managing solder paste, and more particularly, to a system and method for managing storage and usage of a solder paste can.

2. Description of Related Art

There are strict requirements for storage and usage of solder paste in industry. For example, the storage temperature is controlled to be 2-8° C.; solder paste is stored in a can for up to 6 months before the can is open; and before opening the can, the solder paste needs to be warm up to room temperature (25±2° C.), wherein time for warming up the solder paste is about 4 hours, and no heating device is allowed for warming up the solder paste. Currently, the storage and usage of solder paste is manually controlled; however, it is hard to control quality and maintenance of solder paste. Further, since the storage and warm up of solder paste are manually controlled, the quality of solder paste would be poor due to improper warm up, and the manual management would increase cost.

Accordingly, there is a need to develop a system and a method for managing storage and usage of solder paste.

### SUMMARY OF THE INVENTION

The present invention provides a system and a method for managing solder paste, so as to improve management of solder paste and lower labor cost.

The present invention provides a solder paste managing system for managing storage and warm up treatment of a solder paste can, wherein the solder paste managing system is connected to a production managing system, and the solder paste can is stored in a storage room and warmed in a warm up room. The solder paste managing system includes a data bank for recording storage information of the solder paste can stored in the storing room; an analyzing module connected to the production managing system for accessing production information of a production line from the production managing system, and analyzing an amount of solder paste cans; an inquiring module for inquiring a specific solder paste can corresponding to the storage information; and a warm up monitoring module for storing a warm up temperature, obtaining the specific solder paste can, transporting the specific solder paste can from the storage room to the warm up room via a transportation unit, and monitoring a temperature of the warm up room according to the warm up temperature.

The solder paste managing system further includes further includes a storage monitoring module for storing a storage temperature for the solder paste can, monitoring a temperature of the storage room according to the storage temperature, monitoring whether the solder paste can expires according to the storage information, and outputting an alert message while the temperature of the storage room exceeds the storage temperature or the solder paste can expires.

In the solder paste managing system, the warm up monitoring module further includes a warm up warning time for outputting a second alert message while time for warming up the solder paste exceeds the warm up warning time.

The solder paste managing system further includes a receive monitoring module for establishing a receive record according to a record of receiving the solder paste can from the warm up room, and producing a daily record corresponding to the record, wherein the daily record includes a message from a receiver and time at which the solder pastes is received.

The present invention further provides a method for managing solder paste, including the steps of: establishing a data bank for storing storage information corresponding to solder paste cans while the solder paste cans are transmitted to a storage room via a transportation unit, and storing setting information of the solder paste cans, wherein the setting information includes a storage condition and a warm up condition having a warm up temperature; accessing production information from a production managing system, and analyzing an amount of solder paste cans to be needed according to the production information; inquiring a specific solder paste can according to the storage information and based on first-in, first-out; and transporting the specific solder can from the storage room to a warm up room via the transportation unit, recording and calculating time for warm up according to the warm up condition, and monitoring whether a temperature of the warm up room meets the warm up temperature so as to facilitate a warm up treatment of the specific solder paste can.

The method for managing solder paste further includes the step of: monitoring whether a temperature of the storage room meets the storage condition, whether each of the solder paste cans expires, and outputting a first alert message while the temperature of the storage exceeds the storage condition or each of the solder paste cans expires.

In the method of the present invention, the warm up condition further includes a warm up warning time, and while time for warming up the solder paste exceeds the warm up warning time, a second alert message is output.

The method for managing solder paste further includes the step of: automatically producing a daily record according to a record of receiving the specific solder paste can, wherein the daily record includes a message from a receiver and time at which the solder pastes is received.

Hence, in the present invention, the system may automatically monitor the storage temperature, expiration date and warm up treatment of the solder paste, so as to endure quality of the solder paste and further to effectively manage solder paste usage and lower labor cost.

### BRIEF DESCRIPTION OF THE DRAWINGS

FIG. 1A is a schematic view showing the solder paste managing system according to one embodiment of the present invention;

FIG. 1B is a schematic view showing the solder paste managing system according to another embodiment of the present invention; and

FIG. 2 is a flow chart showing the method for managing solder paste according to the present invention.

### DETAILED DESCRIPTION OF THE PREFERRED EMBODIMENTS

The detailed description of the present invention is illustrated by the following specific examples. Persons skilled in the art can conceive the other advantages and effects of the present invention based on the disclosure contained in the specification of the present invention.

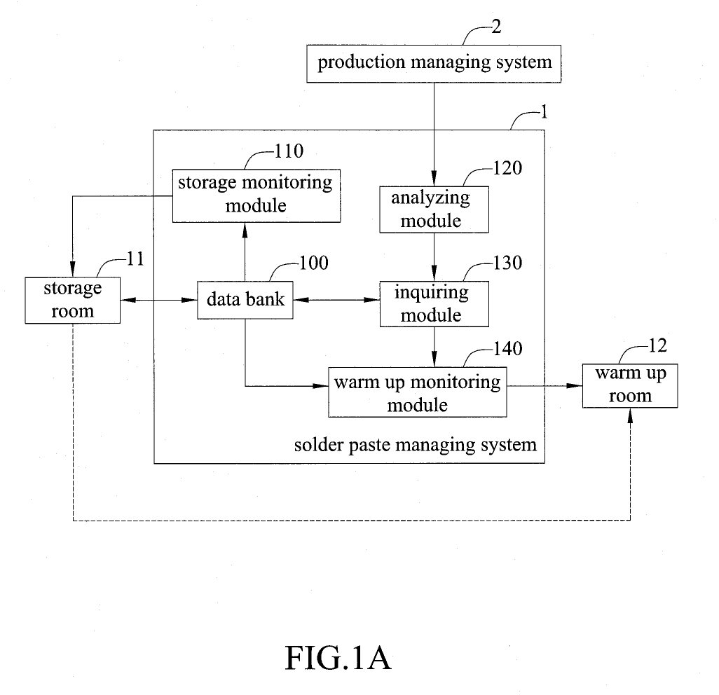

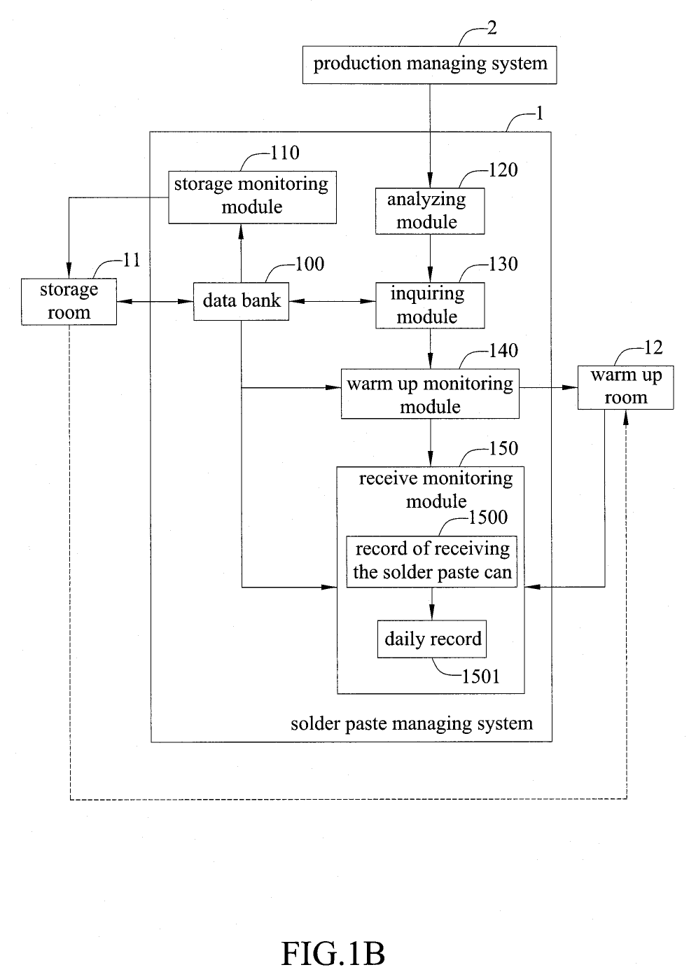

FIG. 1A is a schematic view showing the solder paste managing system of the present invention. As shown in FIG. 1A, a solder paste managing system 1 includes a data bank 100, a storage monitoring module 110, an analyzing module 120, an inquiring module 130 and a warm up monitoring module 140.

The data bank 100 is used for recording storage information of each solder paste can, which is stored in a storage room 11. The storage information includes a mold number, a date at which solder paste is placed into the solder paste can, expiration date and storage amount of each solder paste can. In this embodiment, there is a bar code on each solder paste can, and when the solder paste can is delivered to the storage room 11, the storage information is obtained by scanning the bar code. Further, the data bank 100 may provide a predetermined storage condition for solder paste (storage temperature of solder paste, for example) and a warm up condition (time or temperature for warming up solder paste, for example).

The storage monitoring module 110 monitors the temperature of the storage room 11 according to the storage temperature of solder paste stored in the data bank, and determines whether the temperature of the storage room meets the predetermined storage temperature. In addition, the storage monitoring module 110 monitors whether the solder paste can expires according to the expiration date stored in the data bank 100. The storage monitoring module 110 outputs an alert message to notify a management staff when the solder paste can expires, so as to avoid to use an expired solder paste can and to avoid unqualified products.

The analyzing module 120 is connected to a production managing system 2 for accessing production information associated with production lines from the production managing system 2, and analyzing the amount of solder paste cans to be used according to the production information.

The inquiring module 130 inquires the solder pastes cans, which meet the analysis result of the analyzing module 120, from the storage room according to the storage information, which is stored in the data bank 100 and includes the mold number of the solder paste can, the date at which solder paste is placed into the solder paste can, and the storage amount of the solder paste can, and based on firs-in first-out.

The warm up monitoring module 140 receives the solder paste can, which meets the analysis result of the analyzing module 120, from the storage room 11 according to the inquiring result of the inquiring module 130, and delivers the solder paste can from the storage room 11 to the warm up room 12 for the warm up treatment via a transportation structure (for example, a transportation belt, not shown). When the solder paste can is delivered into the warm up room 12, the information of the solder paste can is scanned by the warm up monitoring module 140, such that the storage information is obtained. The starting time of the warm up treatment is recorded, and the finish time of the warm up treatment is calculated according to the warm up condition, such as time for the warm up treatment. In the warm up treatment, the warm up monitoring module 140 monitors whether the temperature of the warm up room 12 meets the warm up condition, i.e. the predetermined warm up temperature. If the time of the warm up treatment in the warm up room 12 exceeds the warm up warning time, the warm up monitoring module 140 outputs an alert message to notify the staff.

As shown in FIG. 1B, an solder paste managing system 1′ includes a receive monitoring module 150 for automatically producing a daily record 1501 according to a record 1500 of receiving the solder paste can from the warm up room 12, wherein the solder paste can has been warmed up. The daily record 1501 includes information of the receiving staff (for example, staff ID) and time of receiving the solder paste can. Thus, usage of solder paste is effectively managed.

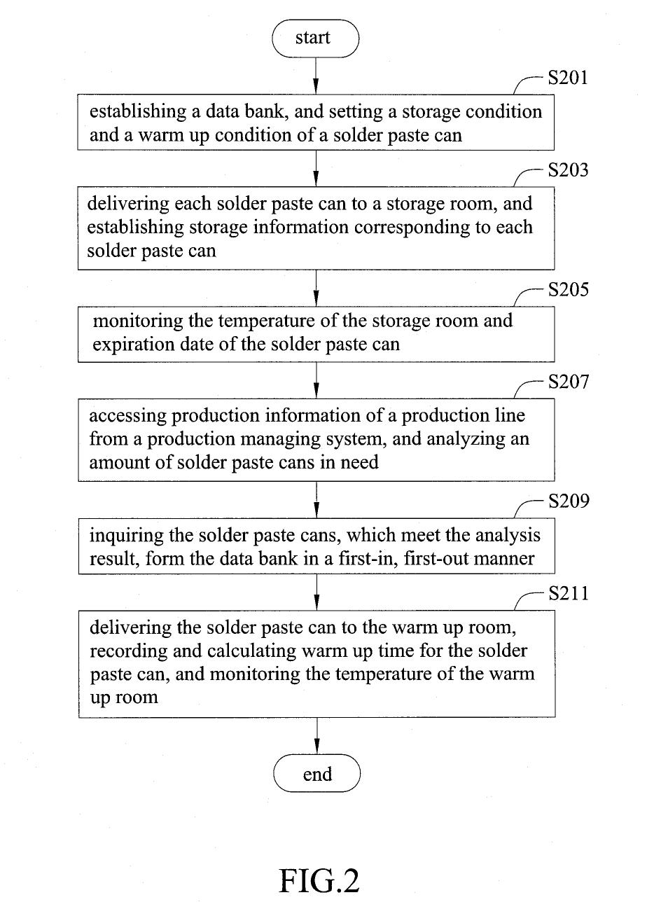

The solder paste managing system of the present invention is illustrated in FIG. 1A and the method for managing solder paste is illustrated in FIG. 2. In the step S201, a data bank 100 is established for storing information of solder paste cans such as storage information of each solder paste can. Further, the data bank 100 provides setting information such as storage information of a solder paste can (for example, storage temperature), and a warm up condition (for example, time for warm up or warm up warning time). The step S203 is then performed.

In the step S203, when the solder paste can is delivered to the storage room 11 via a transportation unit (not shown), the mold number, the date at which solder paste is placed into the solder paste can, the expiration date of the solder paste and the storage amount of the solder paste can are recorded. The above information may be obtained from a bar code on the solder paste can by scanning the bar code while the solder paste can is delivered to the storage room 11. The obtained information is stored in the data bank 100, and storage information corresponding to the solder paste can is established. Then, the step S205 is performed.

In the step S205, the temperature of the storage room 11 is monitored according to the storage condition of the solder paste can in the data bank 100, and it is determined whether the temperature of the warm up room 11 meets the storage condition. If the temperature of the warm up room 11 exceeds the predetermined temperature, an alert message is output to notify the management staff. Also, the expiration date of the solder paste can is monitored according to the expiration date stored in the data bank 100. If the solder paste can expires, an alert message is output to notify the management staff, so as to avoid using the expired solder paste. Then, the step S207 is performed.

In the step S207, the production information (for example, production schedule) is accessed from the production managing system 2, analyzed and calculated to obtain the amount of solder paste cans, which is needed for the production schedule. Then, the step S209 is performed.

In the step S209, inquiring is performed to obtain the solder paste cans, which meet the analysis result, according to the storage information in the data bank 100 and based on first-in, first-out. Then, the step S211 is performed.

In the step S211, the solder paste cans are delivered from the storage room 11 to the warm up room 12 via a transportation unit (for example, a transportation belt, not shown), and the time for warm up is recorded and calculated according to the warm up condition stored in the data bank 100. In the warm up treatment, the temperature of the warm up room 12 is monitored according to the predetermined warm up condition till the warm up treatment is finished. Further, if the time for warming up the solder paste cans in the warm up room 12 exceeds the warm up warning time, an alert is output.

In addition, the method for managing solder paste further includes the step of automatically producing a daily record while the solder paste can, which has been warmed up, is received from the warm up room 12. The daily record includes a message from a receiver and time at which the solder pastes is received. Hence, the usage of solder paste is effectively managed.

Accordingly, in the solder paste managing system and the method for managing solder paste of the present invention, storage information of each solder paste can in the storage room is established, production information of a production line is accessed from a production managing system, the amount of solder paste cans, which are needed, is calculated and obtained, then inquiring is performed to obtain the solder paste cans which meet the analysis result and meet the first-in, first-out manner, the solder paste cans are delivered to the warm up room, and the warm up treatment is monitored. Therefore, the storage and warm up of solder paste is systematically managed, such that efficacy of management is improved, labor cost is reduced, and usage of solder paste is effectively managed. In addition, the temperature of the storage room and the warm up room is monitored, and an alert message would be output if the solder paste in the storage room expires, so as to avoid using expired solder paste, and to ensure product quality.

The invention has been described using exemplary preferred embodiments. However, it is to be understood that the scope of the invention is not limited to the disclosed arrangements. The scope of the claims, therefore, should be accorded the broadest interpretation, so as to encompass all such modifications and similar arrangements.

1. A solder paste managing system for managing storage and warm up treatment of a solder paste can, wherein the solder paste managing system is connected to a production managing system, and the solder paste can is stored in a storage room and warmed in a warm up room, the solder paste managing system comprising:
a data bank for recording storage information of the solder paste can stored in the storing room;
an analyzing module connected to the production managing system for accessing production information of a production line from the production managing system, and analyzing an amount of solder paste cans;
an inquiring module for inquiring a specific solder paste can corresponding to the storage information; and
a warm up monitoring module for storing a warm up temperature, obtaining the specific solder paste can, transporting the specific solder paste can from the storage room to the warm up room via a transportation unit, and monitoring a temperature of the warm up room according to the warm up temperature.

2. The solder paste managing system of claim 1, further comprising a storage monitoring module for storing a storage temperature for the solder paste can, monitoring a temperature of the storage room according to the storage temperature, monitoring whether the solder paste can expires according to the storage information, and outputting an alert message while the temperature of the storage room exceeds the storage temperature or the solder paste can expires.

3. The solder paste managing system of claim 1, wherein the warm up monitoring module further comprises a warm up warning time, and outputs a second alert message while time for warming up the solder paste exceeds the warm up warning time.

4. The solder paste managing system of claim 1, further comprising a receive monitoring module for establishing a receive record according to a record of receiving the solder paste can from the warm up room, and producing a daily record corresponding to the record, wherein the daily record includes a message from a receiver and time at which the solder pastes is received.

5. The solder paste managing system of claim 1, wherein the storage information includes a mold number, a date at which solder paste is placed into the solder paste can, an expiration date and a storage amount.

6. A method for managing solder paste, comprising the steps of:
establishing a data bank for storing storage information corresponding to solder paste cans while the solder paste cans are transmitted to a storage room via a transportation unit, and storing setting information of the solder paste cans, wherein the setting information includes a storage condition and a warm up condition having a warm up temperature;
accessing production information from a production managing system, and analyzing an amount of solder paste cans to be needed according to the production information;
inquiring a specific solder paste can according to the storage information and based on a first-in, first-out manner; and
transporting the specific solder can from the storage room to a warm up room via the transportation unit, recording and calculating time for warm up according to the warm up condition, and monitoring whether a temperature of the warm up room meets the warm up temperature so as to facilitate a warm up treatment of the specific solder paste can.

7. The method of claim 6, further comprising the steps of:
monitoring whether a temperature of the storage room meets the storage condition and whether each of the solder paste cans expires, and outputting a first alert message while the temperature of the storage exceeds the storage condition or each of the solder paste cans expires.

8. The method of claim 6, wherein the warm up condition further comprises a warm up warning time, and while time for warming up the solder paste exceeds the warm up warning time, a second alert message is output.

9. The method of claim 6, further comprising the step of:
producing automatically a daily record according to a record of receiving the specific solder paste can, wherein the daily record includes a message from a receiver and time at which the solder pastes is received.

10. The method of claim 9, wherein the storage information includes a mold number, a date at which solder paste is placed into the solder paste can, an expiration date and a storage amount.
